(19) United States
(12) Patent Application Publication
(10) Pub. No.: US 2026/0235905 A1
(43) Pub. Date: Aug. 13, 2026

(54) LIQUID-CRYSTAL DISPLAY

(71) Applicant: BenQ Materials Corporation, Taoyuan (TW)

(72) Inventors: Kai-Chun Chuang, Taoyuan (TW); Yu-Ju Kao, Taoyuan (TW); Yu Lun Chung, Taoyuan (TW); Kuo-Hsuan Yu, Taoyuan (TW)

(73) Assignee: BenQ Materials Corporation, Taoyuan (TW)

(21) Appl. No.: 19/380,560

(22) Filed: Nov. 5, 2025

(30) Foreign Application Priority Data
Feb. 7, 2025 (TW) 114104514

(51) Int. Cl. G02F 1/1335; G02F 1/1333

(52) U.S. Cl. CPC G02F 1/133545; G02F 1/133311; G02F 1/133502

(57) ABSTRACT

The present invention discloses a liquid crystal display in which the display-side polarizer has a first polyester protective film disposed on light exiting side and the backlight-side polarizer has a second polyester protective film disposed on light incident side, which can reduce stress patterns caused by uneven stress on both sides of the liquid crystal panel due to the residual stress of the polyester protective films, and when the birefringence difference of the first polyester protective film is ranging from 0.003 and 0.015, and the birefringence difference of the second polyester protective film is ranging from 0.030 and 0.080, interference rainbow patterns generated by different light sources such as backlight and external ambient light at different viewing angles of the liquid crystal display can be avoided simultaneously.

### CROSS-REFERENCE TO RELATED APPLICATION

This application claims the priority benefit of Taiwanese Application Ser. No. TW114104514, filed on Feb. 7, 2025, which is incorporated herein by reference.

### BACKGROUND OF THE INVENTION

### Field of Invention

The present invention relates to a liquid crystal display in which, when a polyester protective film is provided on the display-side polarizer or the backlight-side polarizer, stress patterns caused by uneven stress on both sides of the liquid crystal panel due to the residual stress of the polyester protective film can be reduced, while at the same time interference rainbow patterns caused by different light sources, such as from the backlight source and ambient light at different viewing angles, can be prevented.

### Description of Related Art

A liquid crystal display (LCD) comprises a liquid crystal panel, a display-side polarizer and a backlight-side polarizer, and requires a backlight source to provide image light. In order for the display-side polarizer or the backlight-side polarizer to further exhibit better moisture barrier properties, heat resistance and mechanical strength, it is suggested to use a polyester film with crystallization properties in place of a conventional triacetyl cellulose (TAC) film or polymethyl methacrylate (PMMA) film without in-plane retardation, as an outer protective film of the display-side polarizer and the backlight-side polarizer. However, the polyester film, such as commonly used polyethylene terephthalate (PET) film, contain highly crystalline aromatic ring structures and, when manufactured by stretching, exhibit high inherent birefringence and shrinkage stress. If a single polyester film is used as the protective film on one side of the display-side polarizer or the backlight-side polarizer, overall moisture barrier performance cannot be fully improved, and as panel size increases, temperature changes cause increased strain from uneven residual stress, making stress-induced spots more likely to occur. Furthermore, if both the display-side polarizer or backlight-side polarizer have conventional polyester protective films, it is difficult to simultaneously suppress interference rainbow patterns caused by the different light sources from ambient light and form the backlight source at the interfaces between the film layers.

In conventional display-side polarizer using polyester film as protective film, the in-plane retardation (R0) of the polyester film should be very high, such as equal to or greater than 8000 nm. Accordingly, such films often require both a high birefringence difference (Δn) of 0.1 or more and increased thickness, together with primer, hard coating layer to match the refractive index of the polyester film for overcoming the uneven distribution of rainbow patterns and interference fringes caused by obliquely incident backlight or high-intensity ambient light reflections at the interfaces on both sides of the polyester film in the bright state. Alternatively, high haze surface treatment, such as surface function layer with haze equal to or great than 80%, have been employed to scatter incident light and reduce such interference. However, with increasing demands for higher brightness and higher contrast, the polarization and coherence of backlight sources are also increasing. Therefore, optical films such as prismatic concentrators and reflective polarizing brightness enhancement films are widely used in backlight modules to improve collimation and normal viewing brightness, thereby increasing the intensity and utilization efficiency of light entering the liquid crystal display. Therefore, even when employing the above high-retardation polyester films in the display-side polarizer, or when using polyester films as protective films on both the display-side and backlight-side polarizers for improved moisture barrier properties and stress balance, it remains difficult to sufficiently reduce interference rainbow patterns. These patterns, caused by highly collimated, polarized, and coherent image light from the backlight source are significantly visible even at normal viewing angles and thus, degrade the display quality. Furthermore, solely relying on overly high-haze surface function layers also reduce the applicability of the liquid crystal display.

Accordingly, there is a need for a liquid crystal display in which both the display-side polarizer and the backlight-side polarizer are polyester film and which can maintain stress balance on both sides of the liquid crystal panel while having satisfied moisture barrier properties without a surface function layer with a specific surface treatment. Moreover, by coordinating the birefringence differences of the polyester protective film on the light-emitting side of the display-side polarizer and the polyester protective film on the light-entering side of the backlight-side polarizer, the interference caused by ambient light and its reflections at oblique viewing angles can be suppressed and the interference rainbow patterns caused by the collimated, polarized, and coherent light from the backlight source at normal viewing angles can be reduced, especially the image light generated from polarized backlight sources can achieve excellent display performance.

### SUMMARY OF THE INVENTION

An aspect of the present invention is to provide a liquid crystal display comprising a liquid crystal panel with a display-side and a backlight-side opposite to each other; a backlight source disposed on the backlight-side of the liquid crystal panel; a display-side polarizer disposed on the display-side of the liquid crystal panel, comprising a first polarizing film, a first polyester protective film and a surface functional layer, wherein the first polarizing film has a first light-emitting side and a first light-incident side opposite to each other, and the first polarizing film disposed on the display-side of the liquid crystal panel via the first light-incident side, the first polyester protective film is disposed on the first light-emitting side of the first polarizing film, the surface functional layer is disposed on the first polyester protective film, and a birefringence difference of the first polyester protective film is ranging from 0.003 to 0.015; and a backlight-side polarizer disposed on the backlight-side of the liquid crystal panel and between the liquid crystal panel and backlight source, which comprises a second polarizing film and a second polyester protective film, wherein the second polarizing film comprises a second light-emitting side and a second light-incident side opposite to each other, the second light-incident side is toward to the backlight source and the second polarizing film is disposed on the backlight-side of the liquid crystal panel via the second light-emitting side, the second polyester protective film is disposed on the second light-incident side of the second polarizing film, and a birefringence difference of the second polyester protective film is ranging from 0.030 to 0.080.

The liquid crystal display of an embodiment of the present invention, an in-plane retardation of the first polyester protective film is not greater than 1500 nm and the in-plane retardation of the second polyester protective film is not less than 2200 nm.

The liquid crystal display of another embodiment of the present invention, the first polyester protective film has an average refractive index np1 and the second polyester protective film has an average refractive index np2, and the first polyester protective film comprises a first refractive-index-matching layer having a first refractive index n1 and a second refractive-index-matching layer having a first refractive index n2 formed on opposite sides thereof, and the second polyester protective film comprises a third refractive-index-matching layer having a third refractive index n3 and a fourth refractive-index-matching layer having a fourth refractive index n4 formed on opposite sides thereof, and n1, n2 are both less than np1, and n3, n4 are both less than np2.

In still another embodiment of the liquid crystal display of the present invention, the average refractive index np1, np2 are both in the range of 1.60 to 1.70, and the first refractive index n1, the second refractive index n2, the third refractive index n3 and the fourth refractive index n4 are each in the range of 1.51 to 1.65.

In still another embodiment of the liquid crystal display of the present invention, each of the first refractive-index-matching layer, the second refractive-index-matching layer, the third refractive-index-matching layer and the fourth refractive-index-matching layer has a thickness in the range of 0.1 μm to 0.3 μm.

In still another embodiment of the liquid crystal display of the present invention, a thickness of the first polyester protective film is in the range of 20 μm to 80 μm, and a thickness of the second polyester protective film is in the range of 60 μm to 110 μm.

In still another embodiment of the liquid crystal display of the present invention, the first polyester protective film and the second polyester protective film are uniaxial stretched polyester films or biaxial stretched polyester films.

In still another embodiment of the liquid crystal display of the present invention, the first polarizing film and the second polarizing film are iodine-based stretched polarizing films, dye-based stretched polarizing films, iodine-based coated polarizing films or dye-based coated polarizing films.

In still another embodiment of the liquid crystal display of the present invention, the surface functional layer is selected from one of the group consisting of a hard coating layer, an anti-glare layer, an anti-fouling layer, an anti-static layer, and an anti-reflection layer, or combinations thereof.

In still another embodiment of the liquid crystal display of the present invention, a total haze of the surface functional layer is in the range of 1% to 60%.

In still another embodiment of the liquid crystal display of the present invention, a thickness of the surface functional layer is in the range of 2 μm to 10 μm.

In still another embodiment of the liquid crystal display of the present invention, the first polyester protective film and the second polyester protective film are polyethylene terephthalate film, polytrimethylene terephthalate film, or polybutylene terephthalate film.

In still another embodiment of the liquid crystal display of the present invention, the backlight source is a polarized backlight source.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### BRIEF DESCRIPTION OF DRAWINGS

FIG. 1 is a perspective view of a liquid crystal display of an embodiment of the present invention.

FIG. 2 is a perspective view of a liquid crystal display of another embodiment of the present invention.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details.

It is apparent that departures from specific designs and methods described and shown will suggest themselves to those skilled in the art and may be used without departing from the spirit and scope of the invention. The present invention is not restricted to the particular constructions described and illustrated, but should be construed to cohere with all modifications that may fall within the scope of the appended claims.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

In the present disclosure, the term “display-side” refers to the liquid crystal panel in a liquid crystal display that faces the viewer of the display, whereas the term “backlight-side” refers to the side of the liquid crystal panel adjacent to the backlight source.

The liquid crystal display disclosed in the present invention has a first light-emitting side of the display-side polarizer and a second light-incident side of the backlight-side polarizer both comprising polyester protective films to provide an enhanced moisture barrier properties and mechanical strength for the liquid crystal display. Both the first light-emitting side of the display-side polarizer and the second light-incident side of the backlight-side polarizer have polyester protective films, the liquid crystal panel can maintain stress balance on both sides, exhibit satisfied resistance to moisture transmission, achieve enhanced light transmittance, and reduce interface reflection and backlight intensity loss. Furthermore, the liquid crystal display of the present invention can prevent interference fringes caused by oblique reflection of ambient light and can also prevents the generation of visible interference rainbow patterns that disrupt image quality when polarized image light passes through the interface between the two sides of the polyester protective film, especially for backlight sources with high coherence and collimation, which cause significant interference, such as uneven color spots or patterns.

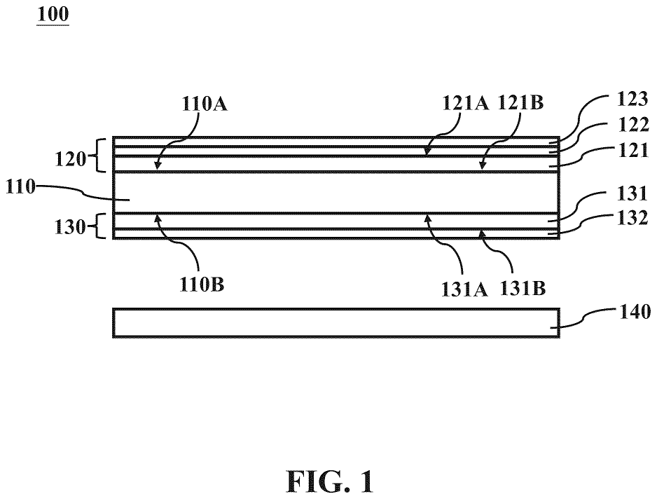

An embodiment of the present invention as shown in FIG. 1 discloses a liquid crystal display 100 comprising a liquid crystal panel 110 with a display-side 110A and a backlight-side 110B; a backlight source 140 disposed on the backlight-side 110B of the liquid crystal panel 110; a display-side polarizer 120 disposed on the display-side 110A of the liquid crystal panel 110, which comprises a first polarizing film 121, a first polyester protective film 122 and a surface functional layer 123. The first polarizing film 121 has a first light-emitting side 121A and a first light-incident side 121B opposite to each other, and the first polarizing film 121 is disposed on the display-side 110A of the liquid crystal panel 110 via the first light-incident side 121B, and the first polyester protective film 122 is disposed on the first light-emitting side 121A of the first polarizing film 121, and the surface functional layer 123 is disposed on the first polyester protective film 122, and the birefringence difference of the first polyester protective film 122 is ranging from 0.003 to 0.015, and a backlight-side polarizer 130 disposed on the backlight-side 110B of the liquid crystal panel 110, comprising a second polarizing film 131 and a second polyester protective film 132. The second polarizing film 131 has a second light-emitting side 131A and a second light-incident side 131B opposite to each other, wherein the second light-incident side 131B is toward to the backlight source 140, and the second polarizing film 131 is disposed on the backlight-side 110B of the liquid crystal panel 110 via the second light-emitting side 131A, the second polyester protective film 132 is disposed on the second light-incident side 131B of the second polarizing film 131, and the birefringence difference of the second polyester protective film 132 is ranging from 0.030 to 0.080.

Since the birefringence difference of the polyester polymers increases with the number of high-refractive-index molecular chain segments and the degrees of the orientation alignment, when the birefringence difference of both the first polyester protective film 122 and the second polyester protective film 132 are both less than 0.1, the films can be manufactured by a low stretch-ratio process, such that the shrinkage of the polyester film in the machine direction (MD) and transverse direction (TD) is more consistent, and the shrinkage induced by elevated temperature is also reduced. Therefore, when the first polyester protective film 122 and the second polyester protective film 132 with low birefringence difference are simultaneously used as the protective film of the liquid crystal display 100, stress on both sides of the liquid crystal display 100 can be more balanced to prevent the stress-induced pattern or uneven color spot appeared in the polarized image generated from the light of the backlight source 140 passing through the second polarizing film 131 and the first polarizing film 121.

Moreover, when the birefringence difference of the first polyester protective film 122 is lower than that of the second polyester protective film 132 in a range of 0.003 to 0.015, the intensity of ambient reflected light at different oblique viewing azimuths of the liquid crystal display 100 can be made more uniform, thereby avoiding interference fringes caused by strong coherent reflection in a specific direction. In addition, the slow axis direction of the first polyester protective film 122 is not necessary to be limited to a single orientation, continuous or discontinuous plural regions with different orientation and therefore, when the first polarizing film 121 used in the display-side polarizer 120, the slow axis of the first polyester protective film 122 can be aligned with the absorption axis of the first polarizing film 121.

When the light of backlight source 140 of the liquid crystal display 100 enters the closest second polyester protective film 132 on the second light-incident side 131B of the second polarizing film 131, since high-intensity light of different wavelengths having collimation and polarization tends to have corresponding constructive interference bands when passing through a thin film with a non-zero in-plane retardation, the image light transmitted through the interfaces of both sides of the second polyester protective film 132 and entering the liquid crystal panel 110 generates strong enhanced and visible perceptible non-uniform color spots or rainbow patterns. By adjusting the birefringence difference of the second polyester protective film 132 to between 0.030 and 0.080, and adjusting the in-plane retardation of the second polyester protective film 132 to ≥2200 nm, the interference fringe regions and spacing widths at both normal and oblique viewing angles can be further reduced. Furthermore, together with the first polyester protective film 122 having in-plane retardation of ≤1500 nm, the light passing through the interference fringe regions is further uniformly reduced after transmitting through the first polyester protective film 122, thereby preventing interference rainbow pattern from being observed at the normal angle, even under a bright-state white display of the liquid crystal panel 110.

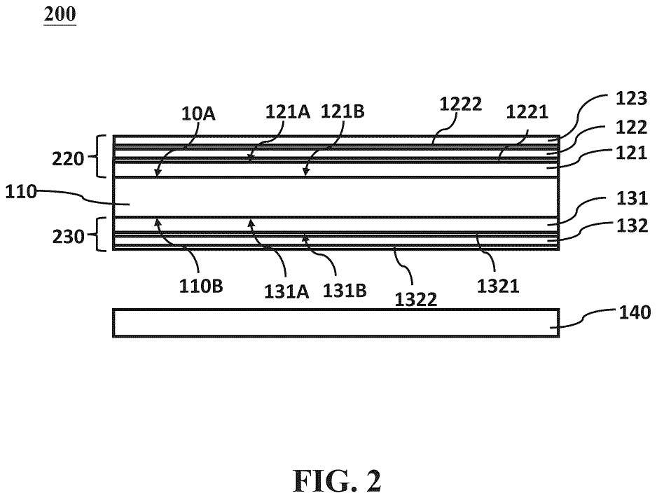

As shown in FIG. 2, it shows another embodiment of the liquid crystal display 200 of the present invention, wherein the two opposite sides of the first polyester protective film 122 has a first refractive-index-matching layer 1221 and a second refractive-index-matching layer 1222 formed thereon, and the two opposite sides of the second polyester protective film 132 has a third refractive-index-matching layer 1321 and a fourth refractive-index-matching layer 1322 formed thereon, and the first refractive index n1 of the first refractive-index-matching layer 1221 and the second refractive index n2 of the second refractive-index-matching layer 1222 are both less than the average refractive index np1 of the first polyester protective film 122, the third refractive index n3 of the third refractive-index-matching layer 1321 and the fourth refractive index n4 of the fourth refractive-index-matching layer 1322 are less than the average refractive index np2 of the second polyester protective film 132. By the refractive index of the refractive-index-matching layer being less than the average refractive index of polyester protective film, a lower interfacial reflectance can be obtained, thereby reducing interference caused by interfacial reflection without adversely affecting the light intensity transmitted through the polyester protective film 132 from the backlight source 140. The first polyester protective film 122 and the second polyester protective film 132, manufactured for example, by stretching a polyethylene terephthalate (PET) film, generally have an average refractive index ranging from 1.60 to 1.70, and the first refractive index n1, the second refractive index n2, the third refractive index n3 and the fourth refractive index n4 are all in the range of 1.51 to 1.65.

In another embodiment of the liquid crystal display 200 of the present invention, the first refractive-index-matching layer 1221, the second refractive-index-matching layer 1222, the third refractive-index-matching layer 1321 and the fourth refractive-index-matching layer 1322 comprise, but are not limited to, coatings of acetalized polyvinyl alcohol, polyurethane, carbamate, polyether resins, polyacrylic resins, isocyanates, or combinations thereof, so as to reduce the refractive index difference between the polyester protective film and air. These layers may be used as an adhesive primer between the first polarizing film 121 or the second polarizing film 131 and other optical films or layers. The refractive index may be selectively adjusted to a desired range by incorporating metal oxide particles, aromatic ring-containing compounds, or the like into the coating. The thickness of the first the refractive-index-matching layer 1221, the second the refractive-index-matching layer 1222, the third the refractive-index-matching layer 1321 and the fourth the refractive-index-matching layer 1322 are each in the range of 0.1 μm to 0.3 μm. Within this thickness range, the refractive-index-matching layers can effectively adjust the refractive index difference on both sides of the first polyester protective film 122 or the second polyester protective film 132 without significantly increasing the thickness of the polyester protective film, so as to avoid adverse effects on stress distribution after subsequent formation of the polarizer.

In still another embodiment of the liquid crystal display of the present invention, the thickness of the first polyester protective film 122 is in the range of 20 μm to 80 μm, and the thickness of the second polyester protective film 132 is in the range of 60 μm to 110 μm. The polyester protective films both have a light transmittance of at least 85%, and preferably 88% or higher. Furthermore, an appropriate thickness contributes to water resistance and mechanical strength, thereby providing excellent protection.

In still another embodiment of the liquid crystal display of the present invention, the first polyester protective film 122 and the second polyester protective film 132 are uniaxial or biaxial stretched polyester film and particularly a uniaxial stretched or biaxial stretched low birefringence polyester film manufactured by a low stretching ratio process. Since the first polyester protective film 122 and the second polyester protective film 132 are polyester films manufactured by a low stretching ratio process, these polyester films have a greater tensile strength and consistent thermal shrinkage ratio in the machine direction and transverse direction. When used in polarizer, the polyester film is together with either a high-stretching-ratio stretched polarizing film or a non-stretching coated polarizing film to form a display-side polarizer or a backlight-side polarizer, the stress distribution on both sides of the liquid crystal panel can be more uniform so as to reduce the occurrence of the stress pattern, to provide more protection and also to be suitable for application in flexible display devices.

In still another embodiment of the liquid crystal display of the present invention, the first polarizing film 121 and the second polarizing film 131 are iodine-based stretched polarizing films, dye-based stretched polarizing films, iodine-based coated polarizing films or dye-based coated polarizing films.

In still another embodiment of the liquid crystal display of the present invention, the surface functional layer 123 of the display-side polarizer 120 is selected from the group consisting of a hard coating layer, an anti-glare layer, an anti-fouling layer, an anti-static layer, and an anti-reflection layer, or a combination thereof. The total haze of the surface functional layer 123 is in the range of 1% to 60%. By surface functional layer 123, the liquid crystal display 100 can be provided with the required haze, surface roughness, or other functional characteristics necessary for visual quality, anti-glare properties, or other performance requirements. The thickness of the surface functional layer 123 is ranging from 2 μm to 10 μm. For imparting anti-glare properties to display, for example, a coating solution prepared by mixing an acrylic based binder resin with particles is coated on a polyester protective film, such as a polyethylene terephthalate film, a polybutylene terephthalate film, or a polytrimethylene terephthalate film. By varying the particles of different sizes, shapes, or ratios of the microparticles and controlling the sedimentation rate, a concave-convex microstructure surface or refractive index difference among particles are created on the film surface to control the haze or surface roughness. The particles used may be organic particles, inorganic particles, or combinations thereof.

Suitable organic microparticles can be polymethyl methacrylate resin microparticles, polystyrene resin microparticles, styrene-methyl methacrylate copolymer microparticles, polyethylene resin microparticles, epoxy resin microparticles, polysilicone resin microparticles, polyvinylidene fluoride resin microparticles, polyvinyl fluoride resin microparticles, melamine resin microparticles, or combinations thereof, with a particle size between 0.3 μm and 6 μm. Suitable inorganic microparticles can be aluminosilicate, talc, mica, silica, or combinations thereof, with a particle size between 0.01 μm and 4 μm.

For providing anti-reflective property to displays, the surface functional layer can be obtained by, for example, coating an anti-reflective coating layer on the protective film. The anti-reflective coating layer is generally prepared by coating a coating solution of an acrylic binder mixed with silica nanoparticles with a particle size between 0.02 μm and 0.3 μm on a protective film, or on a surface functional layer of a protective film with other functions to achieve anti-reflective property.

In still another embodiment of the liquid crystal display of the present invention, the backlight source 140 is a polarized backlight source comprising optical films, such as, a prismatic brightness enhancement film, dual brightness enhancement Film (DBEF), to increase the intensity and utilization of the light entering the backlight-side polarizer of the liquid crystal display.

The present invention will be explained in further detail with reference to the examples. However, the present invention is not limited to these examples.

### EXAMPLE

### Preparation Example 1: Preparation of Acrylate Binder Resin (I)

42 parts by weight of polyurethane acrylate oligomer (functionality of 6, molecular weight of about 2,600, viscosity of 62,000 cps (25° C.), commercially obtained from Miwon Specialty Chemical Co., Ltd., Korea), 4.5 parts by weight of pentaerythritol tetraacrylate (PETA), 12 parts by weight of dipentaerythritol hexaacrylate (DPHA), 3 parts by weight of isobornyl acrylate (IBOA), 4 parts by weight of initiator (Chemcure-481, available from Chembridge International Co., Ltd., Taiwan), 24.5 parts by weight of ethyl acetate (EAC) and 10 parts by weight of n-butyl acetate (nBAC) were mixed and stirred for 1 hour to obtain an acrylic binder resin (I).

### Preparation Example 2: Preparation of Acrylate Binder Resin (II)

42 parts by weight of polyurethane acrylate oligomer (functionality of 6, molecular weight of about 1,600, viscosity of 36,000 cps (25° C.), commercially obtained from IGM, Taiwan), 4.5 parts by weight of pentaerythritol tetraacrylate (PETA), 12 parts by weight of dipentaerythritol hexaacrylate (DPHA), 3 parts by weight of cyclotrimethylolpropane formal acrylate (CTFA), 4 parts by weight of initiator (Chemcure-481, available from Chembridge International Co., Ltd., Taiwan), 24.5 parts by weight of ethyl acetate (EAC) and 10 parts by weight of n-butyl acetate (nBAC) were mixed and stirred for 1 hour to obtain an acrylic binder resin (II).

### Preparation Example 3: Preparation of Acrylate Binder Resin (III)

39 parts by weight of polyurethane acrylate oligomer (functionality of 9, molecular weight of about 2,400, viscosity of 266,000 cps (25° C.), commercially obtained from Taiwan Toagosei Co. Ltd.), 4.5 parts by weight of pentaerythritol tetraacrylate (PETA), 10.5 parts by weight of dipentaerythritol hexaacrylate (DPHA), 4.5 parts by weight of hexaediol diacrylate (HDDA), 1.5 parts by weight of 2-phenoxyethyl acrylate (PHEA), 3.5 parts by weight of initiator (Chemcure-481), 0.5 parts by weight of initiator (TR-PPI-one, commercially obtained from Tronly Enterprise Co. Ltd., Hongkong), 24.5 parts by weight of ethyl acetate (EAC) and 10 parts by weight of n-butyl acetate (nBAC) were mixed and stirred for 1 hour to obtain an acrylic binder resin (III).

### Preparation Example 4: Surface Treatment Solution (I)

152.7 parts by weight of acrylic binder resin (I), 1.6 parts by weight of polymethyl methacrylate microparticles (SSX-102, average particle size of 2 μm, refractive index of 1.49, available from Sekisui Plastics Co., Ltd., Japan), 10.5 parts by weight of silica nanoparticles dispersion sol having nanoparticles with an average primary particle size of 9 nm to 15 nm and connected in chains of 40 nm to 100 nm in length (MEK-ST-UP, solid content of 20%, solvent: methyl ethyl ketone. Available from Nissan Chemical Industries, Ltd., Japan), 5.8 parts by weight of acrylate-ether-containing surfactant (BYK-UV3535, solid content of 10%, solvent: ethyl acetate, available from BYK-Chemie, Germany), 2.1 parts by weight of silica nanoparticles dispersion (NanoBYK-3650, average primary particle size of 20 nm, solid content of 31%, solvent: propylene glycol monomethyl ether acetate/propylene glycol monomethyl ether, available from BYK-Chemie, Germany), 44.3 parts by weight of ethyl acetate (EAC) and 81.8 parts by weight of n-butyl acetate (nBAC), were mixed and stirred for 1 hour for uniformly dispersing to obtain a surface treatment solution (I).

### Preparation Example 5: Surface Treatment Solution (II)

152.7 parts by weight of acrylic binder resin (I), 11.2 parts by weight of methyl methacrylate and styrene copolymer microparticles (XX-49IK, average particle size of 5 μm, refractive index of 1.545, available from Sekisui Plastics Co., Ltd., Japan), 2.9 parts by weight of methyl methacrylate and styrene copolymer microparticles (XX-50IK, average particle size of 3.5 μm, refractive index of 1.555, available from Sekisui Plastics Co., Ltd., Japan), 4.2 parts by weight of polyether-modified polydimethylsiloxane levelling agent (BYK-333, solid content of 10%, solvent: ethyl acetate, available from BYK-Chemie, Germany), 11.4 parts by weight of silica nanoparticles dispersion (NanoBYK-3650, average primary particle size of 20 nm, solid content of 31%, solvent: propylene glycol monomethyl ether acetate/propylene glycol monomethyl ether, available from BYK-Chemie, Germany), 28.6 parts by weight of ethyl acetate (EAC), 57.2 parts by weight of n-propyl acetate (nPAC) and 28.6 parts by weight of propylene glycol methyl ether acetate (PGMEA), were mixed and stirred for 1 hour for uniformly dispersing to obtain a surface treatment solution (II).

### Preparation Example 6: Surface Treatment Solution (III)

152.7 parts by weight of acrylic binder resin (II), 4.0 parts by weight of amorphous silica microparticles (Nipsil® SS-50B, average particle size of 4.0 μm, refractive index of 1.45~1.47, available form Tosoh Silica Corp., Japan), 1.5 parts by weight of a dispersant solution of a block copolymer having basic, pigment-affinic groups (DisperBYK-2150, solid content of 5%, solvents: ethyl acetate and propylene glycol methyl ethyl acetate, available from BYK-Chemie, Germany), 4.7 parts by weight of polyether-modified polydimethylsiloxane levelling agent (BYK-333, solid content of 10%, solvent; ethyl acetate, available from BYK-Chemie, Germany), 68.3 parts by weight of ethyl acetate (EAC) [symbol] 191.1 parts by weight of n-butyl acetate (nBAC), were mixed and stirred for 1 hour for uniformly dispersing to obtain a surface treatment solution (III).

### Preparation Example 7: Surface Treatment Solution (IV)

152.7 parts by weight of acrylic binder resin (III), 2.7 parts by weight of amorphous silica microparticles (Nipsil® SS-50B, average particle size 4.0 μm, refractive index 1.45~1.47, available form Tosoh Silica Corp., Japan), 5.4 parts by weight of polystyrene microparitcles (SSX-302ABE, average particle size of 2 μm, refractive index of 1.595, available from Sekisui Plastics Co., Ltd., Japan), 1.8 parts by weight of a dispersant solution of a block copolymer having basic, pigment-affinic groups (DisperBYK-2150, solid content of 5%, solvents: ethyl acetate and propylene glycol methyl ethyl acetate, available from BYK-Chemie, Germany), 3.3 parts by weight of polyether-modified polydimethylsiloxane levelling agent (BYK-333, solid content of 10%, solvent: ethyl acetate, available from BYK-Chemie, Germany), 57.9 parts by weight of ethyl acetate (EAC) and 86.8 parts by weight of n-butyl acetate (nBAC), were mixed and stirred for 1 hour for uniformly dispersing to obtain a surface treatment solution (IV).

### Preparation Example 8: Surface Treatment Solution (V)

152.7 parts by weight of acrylic binder resin (III), 16.8 parts by weight of polystyrene microparticles (XX-40IK, average particle size of 3 μm, refractive index of 1.595, available from Sekisui Plastics Co., Ltd., Japan), 3.0 parts by weight of silica nanoparticles dispersion sol having nanoparticles with an average primary particle size of 9 nm to 15 nm and connected in chains of 40 nm to 100 nm in length (MEK-ST-UP, solid content of 20%, solvent: methyl ethyl ketone. Available from Nissan Chemical Industries, Ltd., Japan), 11.7 parts by weight of silica nanoparticles dispersion (NanoBYK-3650, average primary particle size of 20 nm, solid content of 31%, solvent: propylene glycol monomethyl ether acetate/propylene glycol monomethyl ether, available from BYK-Chemie, Germany), 30.9 parts by weight of ethyl acetate (EAC), 86.6 parts by weight of n-propyl acetate (nPAC) and 41.9 parts by weight of propylene glycol methyl ether acetate (PGMEA), were mixed and stirred for 1 hour for uniformly dispersing to obtain a surface treatment solution (V).

### Preparation Example 9: Surface Treatment Solution (VI)

152.7 parts by weight of acrylic binder resin (II), 5.3 parts by weight of amorphous silica microparticles (Nipsil® SS-50B, average particle size of 4.0 μm, refractive index of 1.45~1.47, available form Tosoh Silica Corp., Japan), 2.6 parts by weight of a dispersant solution of a block copolymer having basic, pigment-affinic groups (DisperBYK-2150, solid content of 5%, solvent: ethyl acetate and propylene glycol methyl ethyl acetate, available from BYK-Chemie, Germany), 4.7 parts by weight of polyether-modified polydimethylsiloxane levelling agent (BYK-333, solid content of 10%, solvent: ethyl acetate, available from BYK-Chemie, Germany), 62.8 parts by weight of ethyl acetate (EAC) and 189.6 parts by weight of n-butyl acetate (nBAC), were mixed and stirred for 1 hour for uniformly dispersing to obtain a surface treatment solution (VI).

### Preparation Example 10: Surface Treatment Solution (VII)

152.7 parts by weight of acrylic binder resin (III), 5.7 parts by weight of amorphous silica microparticles (Nipsil® SS-50B, average particle size 4.0 μm, refractive index 1.45~1.47, available form Tosoh Silica Corp., Japan), 5.5 parts by weight of polystyrene microparticles (XX-40IK), 2.1 parts by weight of a dispersant solution of a block copolymer having basic, pigment-affinic groups (DisperBYK-2150, solid content of 5%, solvents: ethyl acetate and propylene glycol methyl ethyl acetate, available from BYK-Chemie, Germany), 4.7 parts by weight of polyether-modified polydimethylsiloxane levelling agent (BYK-333, solid content of 10%, solvent: ethyl acetate, available from BYK-Chemie, Germany), 60.2 parts by weight of ethyl acetate (EAC) and 115.1 parts by weight of n-butyl acetate (nBAC), were mixed and stirred for 1 hour for uniformly dispersing to obtain a surface treatment solution (VII).

### Preparation Example 11: Surface Treatment Solution (VIII)

14 parts by weight of fluorine-containing acrylate-modified polysiloxane resin (X-12-2430C, available from Shin-Etsu Chemical Co., Ltd., Japan), 14 parts by weight of a fluorinated polyurethane oligomer with a functionality of 6 (LR6000, commercially available from Miwon, Korea), 1.7 parts by weight of photoinitiator (KIP-160, available from IGM Resin, Netherlands), 103.5 parts by weight of a perfluoropolyether containing (meth)acrylic-modified organosilicone (X-71-1203E, solid content of 20%, solvent: methyl ethyl ketone, available from Shin-Etsu Chemical Co., Ltd., Japan), 198 parts by weight of hollow silica nanoparticle dispersion (Thrulya 4320, solid content of 20%, average primary particle size of 60 nm, solvent: methyl isobutyl ketone, JGC Catalysts and Chemicals Ltd., Japan), 1779 parts by weight of ethyl acetate (EAC) and 890 parts by weight of propylene glycol methyl ether acetate (PGMEA) were mixed and stirred for 10 minutes to obtain a surface treatment solution (VIII).

Table 1 shows various protective film substrates used in the present invention. When the surface treatment solutions prepared in Preparation Example 4 to Preparation Example 11 were applied to the various substrates listed in Table 1, the coated substrates can be used as protective films with surface functional layers for display-side polarizers or used as protective films without coating surface treatment solutions on the light-incident side of backlight-side polarizers.

TABLE 1

| | | The refractive | The refractive | | | |
|---|---|---|---|---|---|---|
| | | index of the first | index of the second | Refractive | Birefringence | |
| | Thickness of | refractive-index- | refractive-index- | index of the | difference of | In-plane |
| | substrate | matching layer | matching layer | substrate | substrate | retardation |
| Substrate | (μm) | (n₁) | (n₂) | (nₚ) | (Δn) | (R0, nm) |
| PET-1 | 75 | 1.56 | 1.64 | 1.66 | 0.033 | 2475 |
| PET-2 | 75 | 1.54 | 1.64 | 1.66 | 0.031 | 2353 |
| PET-3 | 75 | 1.54 | 1.61 | 1.66 | 0.040 | 3037 |
| PET-4 | 75 | 1.56 | 1.61 | 1.66 | 0.047 | 3496 |
| PET-5 | 100 | 1.65 | 1.65 | 1.66 | 0.049 | 4930 |
| PET-6 | 76 | 1.54 | 1.61 | 1.66 | 0.004 | 271 |
| PET-7 | 50 | 1.56 | 1.61 | 1.66 | 0.008 | 407 |
| PET-8 | 50 | 1.56 | 1.64 | 1.66 | 0.009 | 456 |
| PET-9 | 66 | 1.54 | 1.61 | 1.66 | 0.011 | 713 |
| PET-10 | 75 | 1.62 | 1.65 | 1.66 | 0.014 | 1080 |
| PMMA | 40 | 1.50 | — | 1.50 | 0.0000215 | 0.86 |
| TAC | 60 | — | — | 1.48 | 0.0000162 | 0.97 |

### Example 1

The surface treatment solution (I) prepared in Preparation Example 4 was coated on a 76 μm polyethylene terephthalate substrate (PET-6, Brand name: QBN-0016, commercially available from Mitsubishi Chemical Corp., Japan). The thickness, refractive index, birefringence difference (Δn), in-plane retardation and the refractive index of the refractive-index-matching layer of the substrate used in the protective film were shown in Table 1. After drying the surface treatment solution (I), UV curing was conducted under a nitrogen atmosphere using a UV lamp with a radiation dose of 80 mJ/cm² to obtain a first polyester protective film having anti-glare function layer with a thickness of 7.2 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, manufactured by BenQ Materials Corp.), which the existing surface protective film had been removed, to obtain a display-side polarizer. Another polyethylene terephthalate substrate, shown in Table 1, (PET-1, Brand name: QBN-0008, commercially available from Mitsubishi Chemical Corporation, Japan) was adhered by an optical clear adhesive onto the light-incident side of the polarizing film of a commercially available polarizer (Brand name: RTT00015TH, manufactured by BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Example 1.

The thickness and the haze of the surface functional layer of the display-side polarizer obtained in Example 1 were measured by using the devices the methods described below, and the above described liquid crystal display was evaluated for stress pattern and interference rainbow pattern. The measurement and evaluation results are shown in Table 2.

The thickness of surface function layer measurement: The thickness of surface function layer was measured according to the test method of JIS K5600-1-7:2014 by Inductive Dial Comparator Extramess 2001 (manufactured by Mahr Inc., Germany).

Total haze measurement: The total haze was measured according to the test method of JIS K7136 by the NDH-2000 Haze Meter (manufactured by Nippon Denshoku Industries, Japan).

Internal haze and outer haze measurement: The optical film was adhered to a triacetyl cellulose (TAC) substrate with a thickness of 40 μm (T40UZ, available from Fujifilm, Japan) was adhered onto the optical film by a transparent optical adhesive to make the uneven surface of the optical film smooth. In this state, the internal haze and the total haze of the optical film were measured according to the test method of JIS K7136 by the NDH-2000 Haze Meter, and the outer haze of the optical film could be obtained by deducting the internal haze from the total haze thereof.

Stress pattern evaluation: The stress pattern evaluation was evaluated by allowing the assembled liquid crystal display to stand at room temperature for 14 days to ensure sufficient stress relaxation of the internal film layers. The liquid crystal display was then set to full-screen black image (dark state). If there was no visibly noticeable stress pattern, the evaluation was “extremely excellent” (◯), if there was visibly noticeable stress pattern, the evaluation was “poor” (X).

Rainbow pattern evaluation: The rainbow pattern was evaluated by setting the full screen of the liquid crystal display to white image (bright state) and viewing the display at viewing angles of 0 degree and 60 degrees to evaluate the interference rainbow pattern. If there was no identifiable rainbow pattern, the evaluation was “extremely excellent” (◯); if there was an identifiable rainbow pattern, the evaluation was “poor” (X).

### Example 2

The surface treatment solution (II) prepared in Preparation Example 5 was coated on a 50 μm polyethylene terephthalate substrate (PET-7, Brand name: EBQ-410, commercially available from Mitsubishi Chemical Corp., Japan). After drying the surface treatment solution (II), UV curing was conducted under a nitrogen atmosphere using a UV lamp with a radiation dose of 80 mJ/cm² to obtain a first polyester protective film having anti-glare function layer with a thickness of 8.4 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, manufactured by BenQ Materials Corp.), which the existing surface protective film had been removed, to obtain a display-side polarizer. Another polyethylene terephthalate substrate, shown in Table 1, (PET-2) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Example 2.

The liquid crystal display and the surface function layer of the display-side polarizer in Example 2 were evaluated in accordance with the measurements and evaluations performed in Example 1. The measurement and evaluation results are shown in Table 2.

### Example 3

The surface treatment solution (III) prepared in Preparation Example 6 was coated on a 50 μm polyethylene terephthalate substrate (PET-8, Brand name: EBQ-409, commercially available from Mitsubishi Chemical Corp., Japan). After drying the surface treatment solution (III), UV curing was conducted under a nitrogen atmosphere using a UV lamp with a radiation dose of 80 mJ/cm² to obtain a first polyester protective film having anti-glare function layer with a thickness of 4.7 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, to obtain a display-side polarizer. Another polyethylene terephthalate substrate, shown in Table 1, (PET-3, Brand name: QBN-0013, commercially available from Mitsubishi Chemical Corporation, Japan) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Example 3.

The liquid crystal display and the surface function layer of the display-side polarizer in Example 3 were evaluated in accordance with the measurements and evaluations performed in Example 1. The measurement and evaluation results are shown in Table 2.

### Example 4

The surface treatment solution (V) prepared in Preparation Example 8 was coated on a 66 μm polyethylene terephthalate substrate (PET-9, Brand name: QBN-0017, commercially available from Mitsubishi Chemical Corp., Japan). After drying the surface treatment solution (V), UV curing was conducted under a nitrogen atmosphere using a UV lamp with a radiation dose of 80 mJ/cm² to obtain a first polyester protective film having anti-glare function layer with a thickness of 3.2 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, to obtain a display-side polarizer. Another polyethylene terephthalate substrate, shown in Table 1, (PET-4, Brand name: TA084, commercially available from Toyobo Co. Ltd., Japan) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Example 4.

The liquid crystal display and the surface function layer of the display-side polarizer in Example 4 were evaluated in accordance with the measurements and evaluations performed in Example 1. The measurement and evaluation results are shown in Table 2.

### Example 5

The surface treatment solution (VI) prepared in Preparation Example 9 was coated on a 66 μm polyethylene terephthalate substrate (PET-9). After drying the surface treatment solution (VI), UV curing was conducted under a nitrogen atmosphere using a UV lamp with a radiation dose of 80 mJ/cm² to obtain a first polyester protective film having anti-glare function layer with a thickness of 4.5 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, to obtain a display-side polarizer. Another polyethylene terephthalate substrate, shown in Table 1, (PET-4, Brand name: TA084, commercially available from Toyobo Co. Ltd., Japan) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Example 5.

The liquid crystal display and the surface function layer of the display-side polarizer in Example 5 were evaluated in accordance with the measurements and evaluations performed in Example 1. The measurement and evaluation results are shown in Table 2.

### Example 6

The surface treatment solution (IV) prepared in Preparation Example 7 was coated on a 75 μm polyethylene terephthalate substrate (PET-10, Brand name: O700E, commercially available from Mitsubishi Chemical Corp., Japan). After drying the surface treatment solution (IV), UV curing was conducted under a nitrogen atmosphere using a UV lamp with a radiation dose of 80 mJ/cm² to obtain a first polyester protective film having anti-glare function layer with a thickness of 3.4 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, to obtain a display-side polarizer. Another polyethylene terephthalate substrate, shown in Table 1, (PET-5, Brand name: C87H, commercially available from SHINKONG MATERIALS TECH. CO., LTD., Taiwan) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Example 6.

The liquid crystal display and the surface function layer of the display-side polarizer in Example 6 were evaluated in accordance with the measurements and evaluations performed in Example 1. The measurement and evaluation results are shown in Table 2.

### Example 7

The surface treatment solution (VII) prepared in Preparation Example 10 was coated on a 75 μm polyethylene terephthalate substrate (PET-10). After drying the surface treatment solution (VII), UV curing was conducted under a nitrogen atmosphere using a UV lamp with a radiation dose of 80 mJ/cm² to obtain a first polyester protective film having anti-glare function layer with a thickness of 3.4 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, to obtain a display-side polarizer. Another polyethylene terephthalate substrate, shown in Table 1, (PET-5) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Example 7.

The liquid crystal display and the surface function layer of the display-side polarizer in Example 7 were evaluated in accordance with the measurements and evaluations performed in Example 1. The measurement and evaluation results are shown in Table 2.

### Example 8

The surface treatment solution (VIII) prepared in Preparation Example 11 was coated on a first polyester protective film having anti-glare function the same as that used in the liquid crystal display of Example 7. After drying the surface treatment solution (VIII), UV curing was conducted under a nitrogen atmosphere using a UV lamp with a radiation dose of 350 mJ/cm² to obtain an anti-reflective layer with a thickness of 0.13 μm on the anti-glare function layer of the first polyester protective film to achieve a first polyester protective film with anti-glare layer and anti-reflective layer.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, in Table 1, (PET-5) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Example 8.

The liquid crystal display and the surface function layer of the display-side polarizer in Example 8 were evaluated in accordance with the measurements and evaluations performed in Example 1. The measurement and evaluation results are shown in Table 2.

### COMPARATIVE EXAMPLE

### Comparative Example 1

The surface treatment solution (I) prepared in Preparation Example 4 was coated on a 75 μm polyethylene terephthalate substrate (PET-1) [symbol] . After drying the surface treatment solution (I), UV curing was conducted under a nitrogen atmosphere using a UV lamp with a radiation dose of 80 mJ/cm² to obtain a first polyester protective film having anti-glare function layer with a thickness of 6.4 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, in Table 1, (PET-6) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Comparative Example 1.

The liquid crystal display and the surface function layer of the display-side polarizer in Comparative Example 1 were evaluated in accordance with the measurements and evaluations performed in Example 1. The measurement and evaluation results are shown in Table 2.

### Comparative Example 2

The surface treatment solution (II) prepared in Preparation Example 5 was coated on a 75 μm polyethylene terephthalate substrate (PET-2). After drying the surface treatment solution (II), UV curing was conducted under a nitrogen atmosphere using a UV lamp with a radiation dose of 80 mJ/cm² to obtain a first polyester protective film having anti-glare function layer with a thickness of 7.0 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, in Table 1, (PET-7) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Comparative Example 2.

The liquid crystal display and the surface function layer of the display-side polarizer in Comparative Example 2 were evaluated in accordance with the measurements and evaluations performed in Example 1. The measurement and evaluation results are shown in Table 2.

### Comparative Example 3

The surface treatment solution (III) prepared in Preparation Example 6 was coated on a 75 μm polyethylene terephthalate substrate (PET-3). After drying the surface treatment solution (III), UV curing was conducted under a nitrogen atmosphere using a UV lamp with a radiation dose of 80 mJ/cm² to obtain a first polyester protective film having anti-glare function layer with a thickness of 5.0 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, in Table 1, (PET-8) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Comparative Example 3.

The liquid crystal display and the surface function layer of the display-side polarizer in Comparative Example 3 were evaluated in accordance with the measurements and evaluations performed in Example 1. The measurement and evaluation results are shown in Table 2.

### Comparative Example 4

The surface treatment solution (V) prepared in Preparation Example 8 was coated on a 75 μm polyethylene terephthalate substrate (PET-4). After drying the surface treatment solution (V), UV curing was conducted under a nitrogen atmosphere using a UV lamp with a radiation dose of 80 mJ/cm² to obtain a first polyester protective film having anti-glare function layer with a thickness of 3.1 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, in Table 1, (PET-9) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Comparative Example 4.

The liquid crystal display and the surface function layer of the display-side polarizer in Comparative Example 4 were evaluated in accordance with the measurements and evaluations performed in Example 1. The measurement and evaluation results are shown in Table 2.

### Comparative Example 5

The surface treatment solution (VI) prepared in Preparation Example 9 was coated on a 75 μm polyethylene terephthalate substrate (PET-4). After drying the surface treatment solution (VI), UV curing was conducted under a nitrogen atmosphere using a UV lamp with a radiation dose of 80 mJ/cm² to obtain a first polyester protective film having anti-glare function layer with a thickness of 4.3 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, in Table 1, (PET-9) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Comparative Example 5.

The liquid crystal display and the surface function layer of the display-side polarizer in Comparative Example 5 were evaluated in accordance with the measurements and evaluations performed in Example 1. The measurement and evaluation results are shown in Table 2.

### Comparative Example 6

The surface treatment solution (VII) prepared in Preparation Example 10 was coated on a 100 μm polyethylene terephthalate substrate (PET-5). After drying the surface treatment solution (VII), UV curing was conducted under a nitrogen atmosphere using a UV lamp with a radiation dose of 80 mJ/cm² to obtain a first polyester protective film having anti-glare function layer with a thickness of 4.6 μm on the polyethylene terephthalate substrate.

The obtained first polyester protective film having surface functional layer was adhered by an optical clear adhesive onto the light-emitting side of the polarizing film of a commercially available polarizer (Brand name: RTT00015TH, BenQ Materials Corp.), which the existing surface protective film had been removed, in Table 1, (PET-10) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Comparative Example 6.

The liquid crystal display and the surface function layer of the display-side polarizer in Comparative Example 6 were evaluated in accordance with the measurements and evaluations performed in Example 1. The measurement and evaluation results are shown in Table 2.

### Comparative Example 7

The surface treatment solution (IV) prepared in Preparation Example 7 was coated on a 40 μm polymethyl methacrylate substrate (PMMA). After drying the surface treatment solution (IV), UV curing was conducted under a nitrogen atmosphere using a UV lamp with a radiation dose of 80 mJ/cm² to obtain an anti-glare layer with a thickness of 3.5 μm on the polymethyl methacrylate substrate to form a polymethyl methacrylate protective film.

The obtained polymethyl methacrylate protective film with surface functional layer was adhered by an optical clear adhesive onto the light-emitting side of the polarizing film of a commercially available polarizer (Brand name: RTT00015TH, BenQ Materials Corp.), which the existing surface protective film had been removed, to obtain a display-side polarizer. Another polyethylene terephthalate substrate, shown in Table 1, (PET-5) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Comparative Example 7.

The liquid crystal display and the surface function layer of the display-side polarizer in Comparative Example 7 were evaluated in accordance with the measurements and evaluations performed in Example 1. The measurement and evaluation results are shown in Table 2.

### Comparative Example 8

The surface treatment solution (III) prepared in Preparation Example 6 was coated on a 60 μm triacetyl cellulose substrate (TAC). After drying the surface treatment solution (III), UV curing was conducted under a nitrogen atmosphere using a UV lamp with a radiation dose of 80 mJ/cm² to obtain an anti-glare layer with a thickness of 4.3 μm on the triacetyl cellulose substrate to form a triacetyl cellulose protective film.

The obtained triacetyl cellulose protective film with surface functional layer was adhered by an optical clear adhesive onto the light-emitting side of the polarizing film of a commercially available polarizer (Brand name: RTT00015TH, BenQ Materials Corp.), which the existing surface protective film had been removed, in Table 1, (PET-5) was adhered by an optical clear adhesive onto the light-incident side of the polarizing film of a commercially available polarizer (Brand name: RTT00015TH, BenQ Materials Corp.), which the existing protective film on the light-incident side had been removed, to be the second polyester protective film and to form a backlight-side polarizer. The above display-side polarizer and backlight-side polarizer together with the liquid crystal panel and backlight module of a commercially available BenQ 32″ VA C32-310 liquid crystal display were assembled to from the liquid crystal display of Comparative Example 8.

The liquid crystal display and the surface function layer of the display-side polarizer in Comparative Example 8 were evaluated in accordance with the measurements and evaluations performed in Example 1. The measurement and evaluation results are shown in Table 2.

TABLE 2

| | | The | | | | | | Rainbow | Rainbow |
|---|---|---|---|---|---|---|---|---|---|
| | The first | second | Total haze | Outer haze | Inner haze | Thickness | | pattern | pattern |
| | polyester | polyester | of surface | of surface | of surface | of surface | | at 60° | at 0° |
| | protective | protective | function | function | function | function | Stress | viewing | viewing |
| | film | film | layer (%) | layer (%) | layer (%) | layer (μm) | pattern | angle | angle |
| Example 1 | PET-6 | PET-1 | 2.07 | 1.18 | 0.89 | 7.2 | ◯ | ◯ | ◯ |
| Example 2 | PET-7 | PET-2 | 27.16 | 13.22 | 13.94 | 8.4 | ◯ | ◯ | ◯ |
| Example 3 | PET-8 | PET-3 | 31.89 | 27.87 | 4.02 | 4.7 | ◯ | ◯ | ◯ |
| Example 4 | PET-9 | PET-4 | 47.9 | 14.0 | 33.9 | 3.2 | ◯ | ◯ | ◯ |
| Example 5 | PET-9 | PET-4 | 45.05 | 42.07 | 2.98 | 4.5 | ◯ | ◯ | ◯ |
| Example 6 | PET-10 | PET-5 | 32.32 | 20.75 | 11.57 | 3.4 | ◯ | ◯ | ◯ |
| Example 7 | PET-10 | PET-5 | 52.60 | 35.99 | 16.61 | 3.4 | ◯ | ◯ | ◯ |
| Example 8 | PET-10 | PET-5 | 50.73 | 33.62 | 17.11 | 3.5 | ◯ | ◯ | ◯ |
| Comparative | PET-1 | PET-6 | 2.17 | 1.01 | 1.16 | 6.4 | ◯ | X | X |
| Example 1 | | | | | | | | | |
| Comparative | PET-2 | PET-7 | 29.16 | 16.25 | 12.91 | 7.0 | ◯ | X | X |
| Example 2 | | | | | | | | | |
| Comparative | PET-3 | PET-8 | 27.26 | 23.11 | 4.15 | 5.0 | ◯ | X | X |
| Example 3 | | | | | | | | | |
| Comparative | PET-4 | PET-9 | 47.49 | 15.48 | 32.01 | 3.1 | ◯ | X | X |
| Example 4 | | | | | | | | | |
| Comparative | PET-4 | PET-9 | 46.13 | 43.37 | 2.76 | 4.3 | ◯ | X | X |
| Example 5 | | | | | | | | | |
| Comparative | PET-5 | PET-10 | 52.66 | 39.13 | 13.53 | 4.6 | ◯ | X | X |
| Example 6 | | | | | | | | | |
| Comparative | PMMA | PET-5 | 33.84 | 23.81 | 10.03 | 3.5 | X | ◯ | ◯ |
| Example 7 | | | | | | | | | |
| Comparative | TAC | PET-5 | 30.12 | 26.69 | 3.43 | 4.3 | X | ◯ | ◯ |
| Example 8 | | | | | | | | | |

From the results shown in Table 1 and Table 2, both the protective film on the light-emitting side of the display-side polarizer and the protective film on the light-incident side of the backlight-side polarizer are polyester protective films of polyethylene terephthalate films, visible stress pattern in the dark state of the liquid crystal display can be avoided, unlike in Comparative Example 7 and Comparative Example 8 where different protective film substrates were used, resulting in different pressure and tensile strength to the polarizers and unequal shrinkage stress among the layers after lamination to the liquid crystal panel that could not be completely released. Furthermore, when the birefringence difference (Δn) of the first polyester protective film were in the range of 0.003 to 0.015 and the birefringence difference (Δn) of the second polyester protective film were in the range of 0.030 to 0.080 in the Examples, uneven distribution of rainbow colors and interference fringes caused by backlight source and the external oblique reflected light at the interfaces between the two sides of the first polyester protective film, and the interference rainbow patterns that are clearly visible at normal viewing angles caused by the image light with high collimation, polarization, and coherence generated by the high-intensity backlight source, can be simultaneously improved. The two sided polyester protective films have better resistance to water vapor penetration than using only a single high in-plane retardation polyester protective film to avoid the above-mentioned problems. The surface functional layers, such as, anti-glare layer or/and anti-reflective layer on the surface of the first polyester protective film of the display-side polarizer do not need to be high in total haze (for example, greater than 80%) or a specific outer haze/inner haze combination, and can effectively suppress the interference rainbow pattern caused by the reflected light or backlight on the display viewing surface. To avoid using a surface functional layer with high haze or high surface roughness to eliminate the light interfering when the light passing through the interface on both sides of the first layer of polyester protective film, which may reduce the transmittance or clarity of the image light, the present invention can increase the diverse application of liquid crystal displays in different application fields that use two polyester protective films and need to be matched with surface functional layers.

Although the present invention has been disclosed through the above embodiments, these are intended solely for illustrative purposes and should not be construed as limiting the scope of the invention. Various modifications and refinements may be made by those skilled in the art without departing from the spirit and scope of the invention. Accordingly, the scope of protection for the present invention shall be defined by the appended claims.

What is claimed is:

1. An A liquid crystal display, comprising:
a liquid crystal panel with a display-side and a backlight-side opposite to each other;
a backlight source disposed on the backlight-side of the liquid crystal panel;
a display-side polarizer disposed on the display-side of the liquid crystal panel, comprising a first polarizing film, a first polyester protective film and a surface functional layer, wherein the first polarizing film has a first light-emitting side and a first light-incident side opposite to each other, and the first polarizing film disposed on the display-side of the liquid crystal panel via the first light-incident side, the first polyester protective film is disposed on the first light-emitting side of the first polarizing film, the surface functional layer is disposed on the first polyester protective film, and a birefringence difference of the first polyester protective film is ranging from 0.003 to 0.015; and
a backlight-side polarizer disposed on the backlight-side of the liquid crystal panel and between the liquid crystal panel and backlight source, which comprises a second polarizing film and a second polyester protective film, wherein the second polarizing film comprises a second light-emitting side and a second light-incident side opposite to each other, the second light-incident side is toward to the backlight source and the second polarizing film is disposed on the backlight-side of the liquid crystal panel via the second light-emitting side, the second polyester protective film is disposed on the second light-incident side of the second polarizing film, and a birefringence difference of the second polyester protective film is ranging from 0.030 to 0.080.

2. The liquid crystal display as claimed in claim 1, wherein an in-plane retardation of the of the first polyester protective film is not greater than 1500 nm and an in-plane retardation of the second polyester protective film is not less than 2200 nm.

3. The liquid crystal display as claimed in claim 1, wherein the first polyester protective film has an average refractive index np1 and the second polyester protective film has an average refractive index np2, and the first polyester protective film comprises a first refractive-index-matching layer having a first refractive index n1 and a second refractive-index-matching layer having a second refractive index n2 formed on opposite sides thereof, and the second polyester protective film comprises a third refractive-index-matching layer having a third refractive index n3 and a fourth refractive-index-matching layer having a fourth refractive index n4 formed on opposite sides thereof, and n1, n2 are both less than np1, and n3, n4 are both less than np2.

4. The liquid crystal display as claimed in claim 3, wherein np1 and np2 are both in the range of 1.60 to 1.70, and n1, n2, n3 and n4 are each in the range of 1.51 to 1.65.

5. The liquid crystal display as claimed in claim 3, wherein each of the first refractive-index-matching layer, the second refractive-index-matching layer, the third refractive-index-matching layer and the fourth refractive-index-matching layer has a thickness in the range of 0.1 μm to 0.3 μm.

6. The liquid crystal display as claimed in claim 1, wherein a thickness of the first polyester protective film is in the range of 20 μm to 80 μm, and a thickness of the second polyester protective film is in the range of 60 μm to 110 μm.

7. The liquid crystal display as claimed in claim 1, wherein the first polyester protective film and the second polyester protective film are uniaxial stretched polyester films or biaxial stretched polyester films.

8. The liquid crystal display as claimed in claim 1, wherein the first polarizing film and the second polarizing film are iodine-based stretched polarizing films, dye-based stretched polarizing films, iodine dye-based coated polarizing films or dye-based coated polarizing films.

9. The liquid crystal display as claimed in claim 1, wherein the surface functional layer is selected from one of the group consisting of a hard coating layer, an anti-glare layer, an anti-fouling layer, an anti-static layer, and an anti-reflection layer, or combinations thereof.

10. The liquid crystal display as claimed in claim 1, wherein a total haze of the surface functional layer is in the range of 1% to 60%.

11. The liquid crystal display as claimed in claim 1, wherein a thickness of the surface functional layer is in the range of 2 μm to 10 μm.

12. The liquid crystal display as claimed in claim 1, wherein the first polyester protective film and the second polyester protective film are polyethylene terephthalate films, polytrimethylene terephthalate films, or polybutylene terephthalate films.

13. The liquid crystal display as claimed in claim 1, wherein the backlight source is a polarized backlight source.
